(19) United States
(12) Patent Application Publication
(10) Pub. No.: US 2022/0410044 A1
(43) Pub. Date: Dec. 29, 2022

(54) MULTI-FUNCTIONAL FILTRATION APPARATUS AND METHOD

(71) Applicant: Tender Corporation, Littleton, NH (US)

(72) Inventors: Carolyn G. Steele, Littleton, NH (US); Collin Farill, Charlottesville, VA (US)

(21) Appl. No.: 17/724,252

(22) Filed: Apr. 19, 2022

Related U.S. Application Data
(60) Provisional application No. 63/216,354, filed on Jun. 29, 2021.

(51) Int. Cl. B01D 35/30; C02F 1/00; B01D 29/33

(52) U.S. Cl. CPC B01D 35/301; C02F 1/002; B01D 29/333; B01D 2201/4092; B01D 2201/304; B01D 2201/302; C02F 2201/004; C02F 2201/006

(57) ABSTRACT

A multi-functional water filtration apparatus includes an outer housing defining a receptacle for receiving a filter assembly and having an inlet port at a first end for intake of unfiltered water and being open at a second end. The filter assembly includes an endcap closing the second end of the outer housing and a filter element enclosed within the outer housing. The endcap has an outlet port for dispensing filtered water. The outer housing has a flow passageway extending between the inlet port and the outlet port. The filter element is disposed in the flow passageway and has an upstream side in fluid communication with the inlet port and a downstream side in fluid communication with the outlet port. In certain aspects, the filtration apparatus provides multiple attachment options. In further aspects, a method of filtering water is provided.

### CROSS-REFERENCE TO RELATED APPLICATION

This application claims the priority benefit of U.S. provisional application Ser. No. 63/216,354 filed Jun. 29, 2021. The aforementioned application is incorporated herein by reference in its entirety.

### BACKGROUND

The present development relates to filtration devices and, more particularly, to a multi-functional filtration apparatus having a water filter assembly that can be used independently or combined with a single-sided housing for additional attachment options and flexibility in use cases.

### SUMMARY

The multi-functional filtration apparatus herein provides a solution for filtering water from untreated water sources where contaminants are a concern. The apparatus in accordance with this disclosure may advantageously be used while outdoors, when travelling, for emergency preparedness, and so forth.

The apparatus herein includes a filter assembly and a single-sided housing section that attaches to the filter assembly. The flow direction is from an inlet connection on the housing and through the filter assembly to an outlet connection on the filter assembly.

In one aspect, a water filtration apparatus includes an outer housing defining a receptacle for receiving a filter assembly, the outer housing having an inlet port for intake of unfiltered water at a first end and being open at a second end opposite the first end. The filter assembly includes an endcap closing the second end of the outer housing and a filter element enclosed within the outer housing, the endcap having an outlet port for dispensing filtered water. The outer housing has a flow passageway extending between the inlet port and the outlet port. The filter element is disposed in the flow passageway and has an upstream side in fluid communication with the inlet port and a downstream side in fluid communication with the outlet port.

In a more limited aspect, the inlet port comprises a first fastener element comprising an internally threaded connection portion for connection to an externally threaded container and a second fastener element comprising a male tube connector that is configured to slidably receive an end of a flexible inlet tube thereover in a fluid-tight relationship therewith.

In another more limited aspect, the internally threaded connection portion is configured to attach to a commercially available beverage bottle having a threaded neck.

In another more limited aspect, the filter assembly further includes a perforated inner housing receiving the filter element.

In another more limited aspect, the outlet port includes a connector element for attachment to a user-delivery interface. In yet another more limited aspect, the user-delivery interface is selected from the group consisting of a straw, spout, mouthpiece, valve, spigot, and bite valve.

In another more limited aspect, the outlet port comprises a male tube connector that is configured to slidably receive the end of a flexible outlet tube thereover in a fluid-tight relationship therewith.

In another more limited aspect, one or both of the filter element and the filter assembly is replaceable.

In another more limited aspect, the filter element comprises a filter medium selected from the group consisting of fine mesh, activated carbon, catalytic carbon, spun fiber filter medium, string wound filter medium, and a pleated filter medium, and any combination thereof.

In another more limited aspect, the water filtration apparatus further comprises one or more projecting features on an interior wall of the housing releasably engaging one or more complementary channels formed on an outward facing surface of the perforated inner housing. In a still more limited aspect, the one or more channels are nonlinear in shape.

In another more limited aspect, the inner housing is closed at a first end and open at a second end opposite the first end and a portion of the end cap is received within the second end of the inner housing.

In another more limited aspect, the water filtration apparatus further comprises a sealing member providing a sealing interference between the end cap and the second end of the inner housing. In yet another more limited aspect, the sealing member further provides a sealing interference between the end cap and the second end of the outer housing.

In another more limited aspect, the filter element is configured to filter particulate materials having a diameter of at least 0.2 microns.

In another more limited aspect, the water filtration apparatus further comprises a container releasably attachable to the inlet port.

In another aspect, a kit of components usable together to construct a water filtration apparatus is provided comprising an outer housing defining a receptacle for receiving a filter assembly wherein the outer housing has an inlet port for intake of unfiltered water at a first end and is open at a second end opposite the first end. The filter assembly includes an endcap closing the second end of the outer housing and a filter element is enclosed within the outer housing. The endcap has an outlet port for dispensing filtered water. The outer housing has a flow passageway extending between the inlet port and the outlet port. The filter element is disposed in the flow passageway and has an upstream side in fluid communication with the inlet port and a downstream side in fluid communication with the outlet port. The kit further includes a container and a hose attachable to the inlet port and the container.

In a more limited aspect, the inlet port comprises a first fastener element comprising an internally threaded connection portion for connection to an externally threaded water source and a second fastener element comprising a male tube connector that is configured to slidably receive the end of a flexible inlet tube thereover in a fluid-tight relationship therewith.

In still another aspect, a method of filtering water comprises the step of providing a water filtration apparatus having an outer housing defining a receptacle for receiving a filter assembly. The outer housing has an inlet port for intake of unfiltered water at a first end and is open at a second end opposite the first end. The filter assembly includes an endcap closing the second end of the outer housing and a filter element enclosed within the outer housing. The endcap has an outlet port for dispensing filtered water. The outer housing has a flow passageway extending between the inlet port and the outlet port. The filter element is disposed in the flow passageway and has an upstream side in fluid communication with the inlet port and a downstream side in fluid communication with the outlet port. The method further comprises the step of fluidically connecting the inlet port to a source of unfiltered water and moving water from the source of unfiltered water through the inlet port, through the flow passageway and filter element, and to the outlet port.

In a more limited aspect, the inlet port comprises a first fastener element comprising an internally threaded connection portion for connection to an externally threaded water source and a second fastener element comprising a male tube connector that is configured to slidably receive the end of a flexible inlet tube thereover in a fluid-tight relationship therewith.

In another more limited aspect, the method further comprises fluidically coupling a user-delivery interface to the outlet port and exerting a suction force at the outlet port using the user-delivery interface.

### BRIEF DESCRIPTION OF THE DRAWINGS

The invention may take form in various components and arrangements of components, and in various steps and arrangements of steps. The drawings, which are not necessarily to scale, are only for purposes of illustrating preferred embodiments and are not to be construed as limiting the invention.

FIG. 1 is a side elevational view of a filtration apparatus in accordance with an exemplary embodiment of the present invention.

FIG. 2 is a side cross-sectional view of the filtration apparatus appearing in FIG. 1.

FIG. 3 is a partially exploded view of the filtration apparatus appearing in FIG. 1.

FIG. 4 is an exploded side elevational view of the filter assembly.

FIG. 5 is a side cross-sectional view of the filter housing.

FIG. 6 illustrates a filtration apparatus embodiment herein attached to a hydration pack.

FIG. 7 illustrates a filtration apparatus embodiment herein attached to a bottle having a threaded neck finish or fitment.

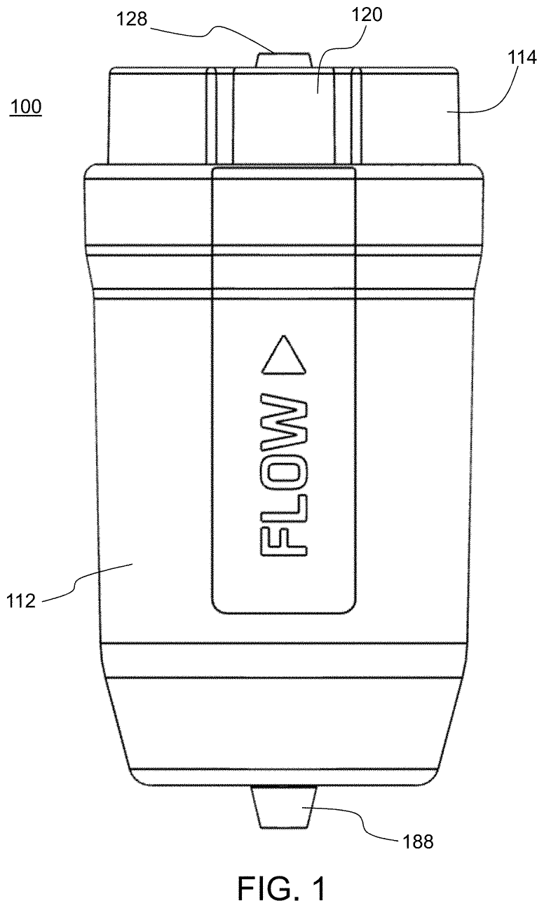

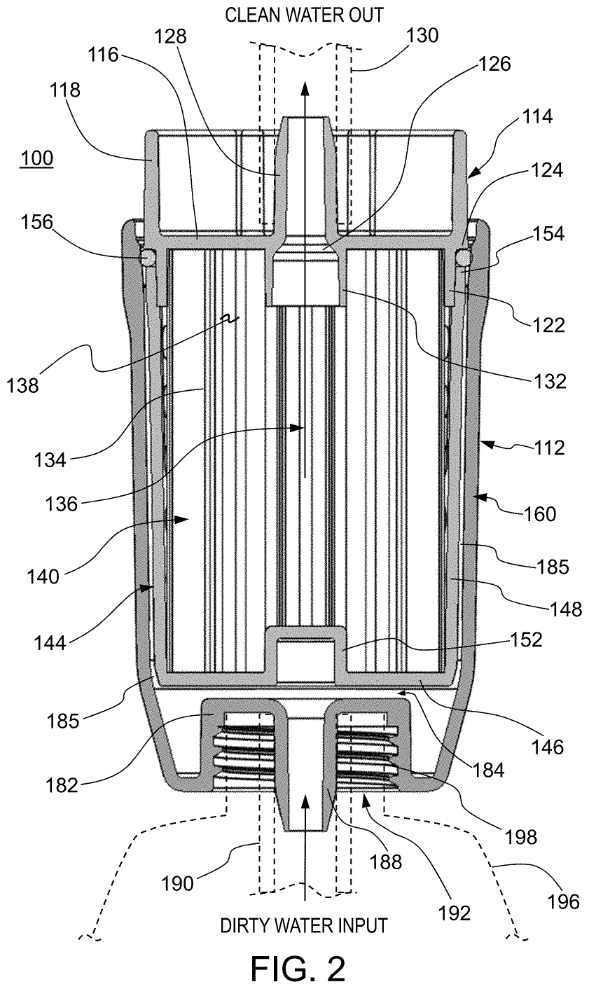

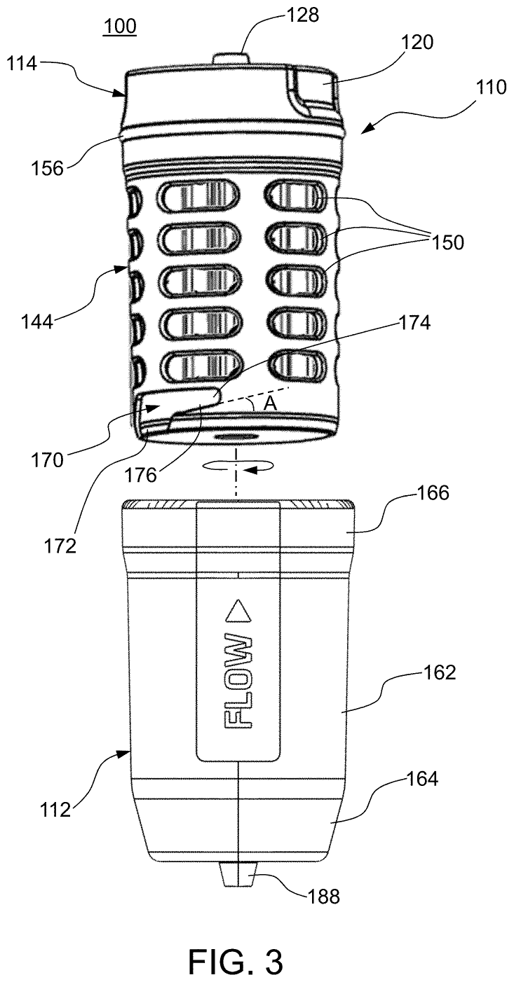

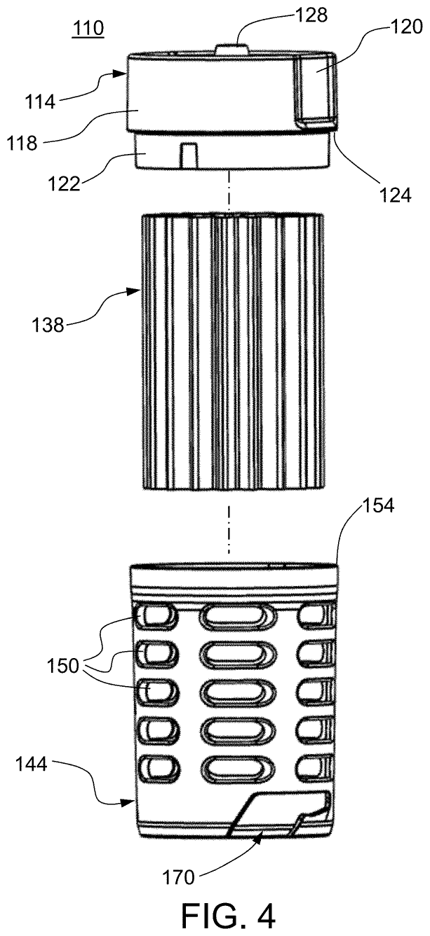

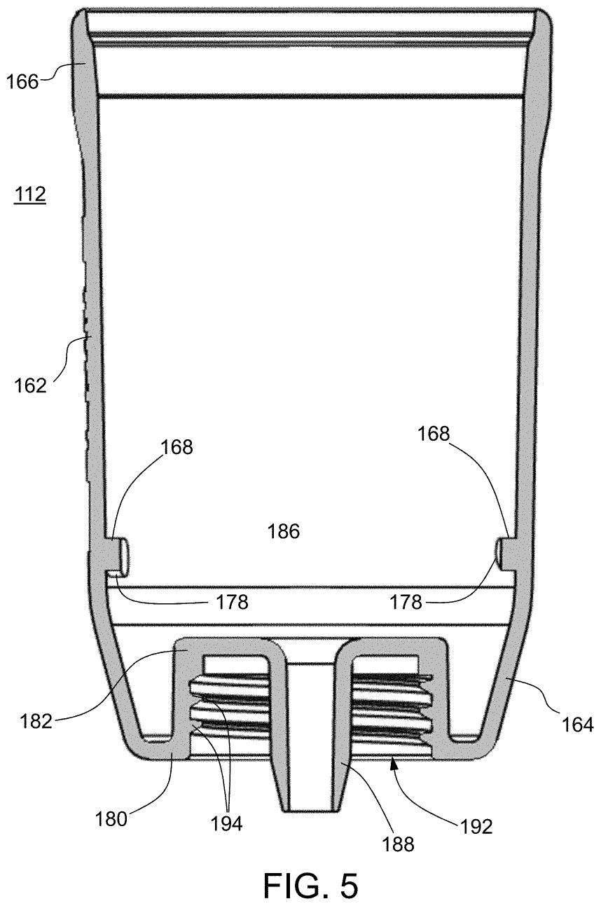

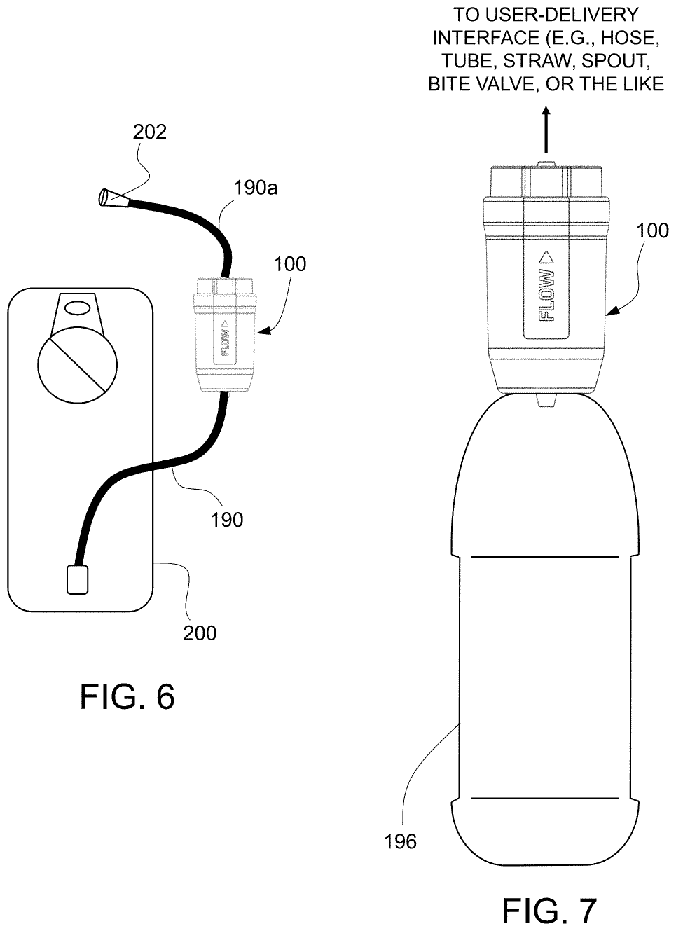

### DETAILED DESCRIPTION OF THE PREFERRED EMBODIMENT(S)

Referring to the drawings, a multi-function filtration apparatus, designated generally as 100, includes a filter assembly 110 removably attached to an external or outer filter housing 112. As used herein, the terms “water filter” and “water filtration” and the like are intended to broadly encompass the removal of impurities from water, lowering contamination of water, and the like, including undesirable chemicals, biological contaminants, suspended solids, and gases. The term “filtration” as used herein is intended to encompass, but is not limited to, purification.

As used herein, terms denoting direction or orientation, such as left, right, front, rear, upper, lower, top, bottom, horizontal, vertical, etc., refer to the orientation of the unit 100 and its components as they appear in the drawings, wherein the inlet is considered to be disposed on the bottom of the outer filter housing 112 and the outlet is considered to be disposed on the top of the filter assembly 110.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected. All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

The filter assembly 110 includes a filter cover or endcap 114. The filter endcap 114 includes a base 116. The base 116 is bounded by an upstanding wall 118 disposed about the periphery of the base 116, which extends upward from the upper surface of the base 116 In certain embodiments, the wall 118 is generally circular. It will be recognized that the wall 118 may be other geometric shapes, and may include flat regions 120 to assist the user in rotating the filter assembly 110 when attaching the filter assembly 110 to the outer housing 112 and when removing the filter assembly 110 from the outer housing 112.

An annular, downward extending outer wall 122 extends from the lower surface of the base 116. The downward extending outer wall 122 is radially inset from the peripheral edge of the base portion 116 to define a shoulder 124.

An aperture 126 is disposed generally centrally on the base 116. A hose or tube connector 128 extends upwardly from the base 116 about the aperture 126 and defines an outlet port for filtered water exiting the apparatus 100. The connector 128 is configured to attach to a hydration hose or tube 130, which may alternatively or additionally include another type of user-delivery interface, such as a straw, spout, mouthpiece, valve, spigot, bite valve, or the like. The hose or tube 130 is preferably formed of a food grade polymer material such as polyethylene, polypropylene, and others.

Although the connector 128 is illustrated as a generally cylindrical connector with a tapered end, it will be recognized that other configurations are contemplated, including non-tapered stubs, tube or hose fittings having one or more barbs, one or more sealing ribs, or the like, as would be understood by persons skilled in the art. In certain embodiments, the connector 128 is sized to be received within a standard or common hose size, such as ¼ inch, 5/16 inch, and so forth. Other fluid connection types, including but not limited to quick connect/disconnect connectors and dripless or self-sealing systems, as known in the art pertaining to connection of fluid-carrying hoses or tubing, are also contemplated.

The opposite end of the hose 130 may be connected to a valve, such as a bite valve 202 of the type which can be opened by manipulation of the user's mouth to allow the user to draw water through the clean water outlet port 128 via suction, as would be understood by persons skilled in the art.

An annular, downward extending inner wall 132 is concentric with the outer wall 122 and is disposed on the lower surface of the base 116 about the aperture 126. The inner wall 132 extends into the upper end of a central passageway 136 within a filter element 134.

The filter element 134 comprises a filtration medium 138 which is formed into a generally cylindrical shape to define the central passageway 136. The filter element 134 is illustrated as a pleated type filter. It will be recognized that other filter elements using other types of filtration media are also contemplated, such as string wound filters, poly spun filters, activated carbon filters, activated charcoal filters, and the like, are also contemplated.

In operation, unfiltered water from the exterior side 140 of the filter element 134 passes through the filter medium 138 whereby impurities are removed and clean water passes into the central passageway 136.

The filter element 134 engages the inner wall 132 and the lower surface of the base 116 in a watertight manner to prevent unfiltered water from the exterior side 140 of the filter element 134 from passing into the central passageway 136 by going around the upper end of the filter element 134.

The filtration element 134 is received within a perforated inner housing such as filter cage 144. The filtration cage 144 is generally cup shaped and is closed at its bottom end and open at its upper end.

The filter cage 144 includes a water-impervious base 146 and an annular, generally cylindrical wall 148 extending upward therefrom. The wall 148 includes a plurality of openings or apertures 150 or is otherwise permeable to water.

An upstanding boss 152 is formed on the base 146 and is received within the central passageway 136 at the lower end of the filter element. Like the base 146, the boss 152 is impervious to water. The lower end of the filter element 134 engages the base 146 and the boss 152 in a watertight manner to prevent unfiltered water from the exterior side 140 of the filter element 134 from passing into the central passageway 136 by going around the lower end of the filter element 134. In this manner, water passing from the exterior 140 to the central passageway 136 must pass through the filtration medium 138.

At least a portion of the downward extending wall 122 is received within the open upper end of the wall 148 to secure the filter endcap 114 to the cage 144. In certain embodiments, the downward extending wall 122 is removably received within the open upper end of the inner housing wall 148. In certain embodiments, the filter endcap 114 is secured to the cage 144 via a fastening method selected from a friction fit, interference fit, press fit, snap fit, adhesive bonding, threaded interface, or the like. In certain embodiments, the downward extending wall 122 is removably received within the open upper end of the wall 148.

The open end of the wall 148 has an upper edge 154. A sealing member 156, such as an O-ring or gasket, is disposed between the shoulder 124 and the upper edge 154 to provide a sealing interference therebetween.

It will be recognized that the filter assembly 110 described herein can be used independently. In the depicted embodiments, the filter assembly 110 is used in conjunction with the one sided outer housing 112.

The outer housing 112 includes a sidewall 160 which has a generally cylindrical middle portion 162, an inwardly tapered lower portion 164, and an outwardly flared upper portion 166 which opens to the top.

The interior surface of the generally cylindrical middle portion 162 includes one or more projecting features such as lugs 168 that are configured to be lockable with a corresponding number of slots or channels 170 on the lower end of the exterior surface of the cage 144. In the depicted embodiment, the one or more channels 170 are configured as generally L-shaped locking channels 170 comprising a generally vertical (i.e., axially-extending) leg portion 172 and a generally horizontal leg portion 174. Two lugs 168 and two corresponding channels 170 are illustrated in the depicted embodiment, although other numbers of aligned lug/channel pairs are contemplated, e.g., 1, 3, 4, 5, and others.

The L-shaped channels 170 permit the filter assembly 110 to releasably interlock with the outer housing 112, e.g., when a user rotates the filter assembly 110 with the lugs 168 engaging the slots 170 when placing the filter assembly 110 into the outer housing 112. In certain embodiments, the generally horizontal leg portion 174 of the L-shaped channel 170 includes an angled lower surface 176 which extends upwardly at an angle A above horizontal, that is, an angle A with respect to a transverse axis of the inner housing 144. The angled surface 176 provides a camming action when the filter assembly 110 is rotated to draw the filter assembly 110 downward and fully seat the filter assembly 110 in the outer housing 112. In certain embodiments, the angle A may be about 1 to about 15 degrees, e.g., 1°, 2°, 3°, 4°, 5°, 6°, 7°, 8°, 9°, 10°, 11°, 12°, 13°, 14°, or 15°. In certain embodiments, the projecting features 168 have a lower surface 178 which are likewise angled at the angle A of the lower surface 176. The sealing member 156 provides a sealing interference between the filter assembly 110 and the upper end of the sidewall 160.

In alternative embodiments, the lower end 146 of the filter cage 144 and the interior or inward facing surface of the cylindrical wall portion 162 can include other structures to releasably connect the filter assembly 110 to the outer housing 112. For example, in certain embodiments, the protrusions 168 can be spring loaded and the slots 170 can be replaced with a complementary recess for releasably securing the filter assembly 110 within the outer housing 112.

The inwardly tapered lower portion 164 includes a base 180 having an upstanding (e.g., cylindrical) boss 182 extending into the interior compartment defined by the outer housing 112. The taper is configured to keep the base 146 of the inner housing 144 spaced apart from the boss 182 to define a gap 184 there between. The gap 184 is in fluid communication with a gap 185 between the housing sidewall 162 and the perforated sidewall 148 of the cage 144.

A central opening 186 is provided in the boss 182 and a hose or tube connector 188 extends downwardly from the opening 186 and defines an inlet port for unfiltered water entering the apparatus 100. The connector 188 is a male tube or hose connector that is configured to slidably receive the end of a flexible hose or tube 190 in a fluid-tight relationship therewith. Although the connector 188 is illustrated as a generally cylindrical connector with a tapered end, it will be recognized that other configurations are contemplated, including non-tapered stubs, tube or hose fittings having one or more barbs, one or more sealing ribs, or the like, as would be understood by persons skilled in the art. The hose or tube 190 is preferably formed of a food grade polymer material such as polyethylene, polypropylene, and others. In operation, the distal end of the hose or tube 190 may be attached to a source of unfiltered water, such as a hydration pack bladder or reservoir 200. In embodiments, filtered water exits the outlet 128 and passes via a hose 130 to a user-delivery interface, such as a bite valve 202 or the like. As used herein, unless stated otherwise, the terms “hose” and “tube” are used interchangeably, without regard to possible nuances in connotation.

The boss 182 further defines an exterior cavity 192 having internal helical threads 194 which provides a second means for providing a fluidic coupling between a source of unfiltered water and the inlet of the apparatus 100. In certain embodiments, the threads 194 are configured to removably engage a externally threaded fitment 198 on a container 196, such as a water bottle (including bottled water bottles), soda bottle, or the like. Other containers 196 contemplated include spouted pouches or bags formed of a flexible material, e.g., flexible polymer film, having a threaded spout or fitment that is complementary with the threads 194 of the threaded opening 192.

In certain embodiments, the threaded opening 192 and threads 194 have a diameter, pitch, and thread size and shape to accommodate a 28 mm threaded fitment. In certain embodiments, the threaded opening 192 and threads 194 have a diameter, pitch, and thread size and shape to accommodate one or more industry standards or guidelines for threaded fitments or neck finishes for commercially available threaded beverage bottles, such as water bottles, soda bottles, and the like. In preferred embodiments, the threaded opening 192 and threads 194 are configured for attachment to a 28 mm diameter threaded fitment, finish, or spout in accordance with a bottling and/or beverage industry standard, such as Alcoa, Orbist, PCO, PCO 1810, PCO 1881, SP400, SP410, SP415, and others.

In operation, a threaded container 196 is filled with unfiltered water to be filtered and the apparatus 100 is threaded onto the threaded fitment 198 of the container 196 via the internally threaded cavity 192. The container 196 is then squeezed to force water through the inlet opening 186. Alternatively, the connector 188 is attached to a hose or tube 190 which, in turn, is connected to a source of unfiltered water, such as the hydration pack/reservoir 200. Water is then drawn through the inlet opening 186 via suction at the outlet port 128, e.g., via user-generated suction via a spout, straw, mouthpiece bite valve, or similar interface.

Water entering the inlet 186 passes around the base of the cage 144 via the gap 184 and through the water permeable cage sidewall 148. Water then passes through the filtration medium 140 whereby impurities are removed as it passes into the central passageway 136. Filtered water in the central passageway 136 then continues through the outlet port 128.

The invention has been described with reference to the preferred embodiments. Modifications and alterations will occur to others upon reading and understanding the preceding detailed description. It is intended that the invention be construed as including all such modifications and alterations insofar as they come within the scope of the appended claims and their equivalents.

What is claimed is:

1. A water filtration apparatus, comprising:
an outer housing defining a receptacle for receiving a filter assembly, the outer housing having an inlet port at a first end and being open at a second end opposite the first end, the inlet port for intake of unfiltered water;
said filter assembly comprising an endcap closing the second end of the outer housing and a filter element enclosed within the outer housing, the endcap having an outlet port for dispensing filtered water; and
said outer housing having a flow passageway extending between the inlet port and the outlet port, the filter element disposed in the flow passageway and having an upstream side in fluid communication with the inlet port and a downstream side in fluid communication with the outlet port.

2. The water filtration apparatus of claim 1, wherein said inlet port comprises a first fastener element comprising an internally threaded connection portion for connection to an externally threaded container and a second fastener element comprising a male tube connector that is configured to slidably receive an end of a flexible inlet tube thereover in a fluid-tight relationship therewith.

3. The water filtration apparatus of claim 2, wherein the internally threaded connection portion is configured to attach to a commercially available beverage bottle having a threaded neck.

4. The water filtration apparatus of claim 1, wherein said filter assembly further comprises a perforated inner housing receiving the filter element.

5. The water filtration apparatus of claim 1, wherein the outlet port includes a connector element for fluidic coupling to a user-delivery interface.

6. The water filtration apparatus of claim 1, wherein said outlet port comprises a male tube connector that is configured to slidably receive the end of a flexible outlet tube thereover in a fluid-tight relationship therewith.

7. The water filtration apparatus of claim 1, wherein one or both of the filter element and the filter assembly is replaceable.

8. The water filtration apparatus of claim 1, wherein the filter element comprises a filter medium selected from the group consisting of fine mesh, activated carbon, catalytic carbon, spun fiber filter medium, string wound filter medium, and a pleated filter medium, and any combination thereof.

9. The water filtration apparatus of claim 4, further comprising one or more projecting features on an interior wall of the outer housing releasably engaging one or more complementary channels formed on an outward facing surface of the perforated inner housing.

10. The water filtration apparatus of claim 9, wherein the one or more channels are nonlinear in shape.

11. The water filtration apparatus of claim 4, wherein the perforated inner housing is closed at a first end and open at a second end opposite the first end, and further wherein a portion of the end cap is received within the second end of the inner housing.

12. The water filtration apparatus of claim 4, further comprising a sealing member providing a sealing interference between the end cap and the second end of the perforated inner housing.

13. The water filtration apparatus of claim 12, wherein the sealing member further provides a sealing interference between the end cap and the second end of the outer housing.

14. The water filtration apparatus of claim 1, wherein the filter element is configured to filter particulate materials having a diameter of at least 0.2 microns.

15. The water filtration apparatus of claim 1, further comprising a container releasably attachable to the inlet port.

16. A kit of components for use in constructing a water filtration apparatus, the kit comprising:
an outer housing defining a receptacle for receiving a filter assembly, the outer housing having an inlet port at a first end and being open at a second end opposite the first end, the inlet port for intake of unfiltered water;
said filter assembly comprising an endcap closing the second end of the outer housing and a filter element enclosed within the outer housing, the endcap having an outlet port for dispensing filtered water;
said outer housing having a flow passageway extending between the inlet port and the outlet port, the filter element disposed in the flow passageway and having an upstream side in fluid communication with the inlet port and a downstream side in fluid communication with the outlet port;
a container; and
a hose attachable to the inlet port and the container.

17. The kit of claim 16, wherein said inlet port comprises a first fastener element comprising an internally threaded connection portion for connection to an externally threaded water source and a second fastener element comprising a male tube connector that is configured to slidably receive the end of a flexible inlet tube thereover in a fluid-tight relationship therewith.

18. A method of filtering water, the method comprising:
providing a water filtration apparatus, the water filtration apparatus comprising:
an outer housing defining a receptacle for receiving a filter assembly, the outer housing having an inlet port at a first end and being open at a second end opposite the first end, the inlet port for intake of unfiltered water;
said filter assembly comprising an endcap closing the second end of the outer housing and a filter element enclosed within the outer housing, the endcap having an outlet port for dispensing filtered water; and
said outer housing having a flow passageway extending between the inlet port and the outlet port, the filter element disposed in the flow passageway and having an upstream side in fluid communication with the inlet port and a downstream side in fluid communication with the outlet port;
fluidically connecting the inlet port to a source of unfiltered water; and
moving water from the source of unfiltered water through the inlet port, through the flow passageway and filter element, and to the outlet port.

19. The method of claim 18, wherein said inlet port comprises a first fastener element comprising an internally threaded connection portion for connection to an externally threaded water source and a second fastener element comprising a male tube connector that is configured to slidably receive the end of a flexible inlet tube thereover in a fluid-tight relationship therewith.

20. The method of claim 18, further comprising:
fluidically coupling a user-delivery interface to the outlet port; and
exerting a suction force at the outlet port using the user-delivery interface.
